(19) United States
(12) Patent Application Publication
(10) Pub. No.: US 2023/0376522 A1
(43) Pub. Date: Nov. 23, 2023

(54) PRESENTATION CONTROL SYSTEM

(71) Applicant: Showhere Limited, London (GB)

(72) Inventors: Patrick Eley, London (GB); Tom Van de Velde, London (GB); Joy Nazzari, London (GB)

(21) Appl. No.: 18/228,613

(22) Filed: Jul. 31, 2023

Related U.S. Application Data
(63) Continuation of application No. PCT/GB2022/050265, filed on Feb. 1, 2022.

(30) Foreign Application Priority Data
Feb. 1, 2021 (GB) 2101389.1

(51) Int. Cl. G06F 16/438; G06F 3/04883; G06F 3/0482

(52) U.S. Cl. CPC G06F 16/4393; G06F 3/04883; G06F 3/0482

(57) ABSTRACT

A presentation control device is described. The presentation comprises presentation elements each to be displayed individually in a sequence on the presentation screen. The presentation control device comprises: a graphical user interface providing a navigation layer to enable a presenter to select a current presentation element for display, the navigation layer including a representation of each of the presentation elements arranged to show a predetermined default sequence in which each of the presentation elements are to be displayed, each presentation element having a unique identifier and each representation being linked to a specific one of the presentation elements using the unique identifier; a presenter input command receiving engine to receive a presenter input command and to operate with the navigation layer to enable selection of a specific representation element for display; and a communications engine for transmitting the unique identifier of the currently selected presentation element for display.

### CROSS-REFERENCES TO RELATED APPLICATIONS

This application is a continuation application of International Patent Application No. PCT/GB2022/050265 entitled “PRESENTATION CONTROL SYSTEM,” filed on Feb. 1, 2022, which claims priority to GB Patent Application No. 2101389.1, filed on Feb. 1, 2021, all of which are herein incorporated by reference in their entirety for all purposes.

### FIELD

The present invention relates to a presentation control system and method. In particular, the present invention relates to a presentation control system for and a method of facilitating the delivery of complex presentations, specifically those which contain a multitude of themes or topics.

### BACKGROUND

Existing presentation software systems such as PowerPoint® and Keynote® typically operate using a linear presentation structure to display slides of the presentation in a consecutive sequence. When a presenter wishes to skip slides to view a later slide within the series (e.g., to skip slides that are irrelevant for a particular audience), or return to a much earlier slide, the viewer is forced to wait and watch as the presenter visibly transitions through numerous slides. This can be perceived as being unprofessional and can lose the interest of the audience. It is however time consuming and laborious to create different presentations with very similar content for different audiences.

There is therefore a need to provide a more flexible means of presenting content to viewers and/or to provide a presentation which appears to be of high quality without undue delays in the presentation.

### SUMMARY

According to one aspect of the present invention there is provided a presentation control device for controlling the delivery of a presentation to a presentation screen operated by a presentation device, the presentation comprising a plurality of presentation elements which are each to be displayed individually in a sequence on the presentation screen, the presentation control device comprising: a graphical user interface providing a navigation layer configured to enable a presenter to select a current presentation element to be displayed, the navigation layer including a representation of each of the presentation elements arranged to show a predetermined default sequence in which each of the presentation elements are to be displayed on the presentation screen, each presentation element having a unique identifier and each representation being linked to a specific one of the presentation elements using the unique identifier; a presenter input command receiving engine configured to receive a presenter input command and to operate with the navigation layer to enable selection of a specific representation element for display during a presentation, wherein navigation layer is configured to enable selection of the current presentation element which changes the predetermined default sequence; and a communications engine for transmitting the unique identifier of the currently selected presentation element for display on the presentation screen.

The communications engine may be configured to transmit the unique identifier of the currently selected presentation element directly to a presentation device via a wireless communications channel. This advantageously enables the presentation control device to directly indicate to the presentation device which presentation element of the presentation is to be displayed next. The direct nature of the communication makes the control of the presentation faster and avoids possible communications channel lag which may arise for indirect communications, for example via wide area networks.

The communications engine may be configured to transmit the unique identifier of the currently selected presentation element to a remote server to be provided to the presentation device via a wide area network. This feature is useful if a direct link is not possible between the presentation control device and the presentation device of if there are multiple presentation devices in different locations being used such that all of them need to be updated with the selected presentation element simultaneously.

In some embodiments, the communications engine is also configured to transmit location information indicating the current position of the currently selected presentation element within the predetermined sequence of presentation elements.

The navigation layer of the graphical user interface may comprise a grid-like formation, with units of the orthogonal axes of the grid indicating different amounts of movement along the predetermined sequence to select a current presentation element. In this way unit movement in one axis may result in adjacent presentation elements being selected whereas unit movement in the orthogonal axis may result in non-adjacent presentation elements being accessed. In this way navigation of a sequence of presentation elements is made far easier as the presenter can rapidly move from one end of the presentation to the other without having to go through each of the presentation elements between those positions. This is effectively a way of skipping over adjacent presentations elements in a sequence of presentation elements to provide greater flexibility and speed in altering a predetermined default presentation.

Preferably, the grid-like formation comprises rows and columns and navigation between adjacent rows comprises movement from a current presentation element being displayed to an adjacent presentation element in the predetermined sequence and navigation between adjacent columns comprises movement from a current presentation element being displayed to a presentation element which is not adjacent in the predetermined sequence. This enables faster navigation to any presentation element in the presentation from a given starting point. For example if the presentation is made up of 100 presentation elements arranged in a grid of say 10 rows by 10 columns, then a movement from one row to the next in the same column can access presentation elements which are adjacent one another namely moving +1 along the sequence of the presentation. Movement along the same row but to a different column can enable a move of up to +10 along the sequence. In some embodiments where different topics are provided in different columns (see below), such a movement along a row may actually automatically move the selected (current) presentation element to the first row of the new column (such that the first presentation element of a group of presentation elements representing a topic can now be accessed). This makes the navigation for a presenter far easier than in prior art systems.

In some embodiments, each column of the grid-like formation represents a user-defined category of the plurality of presentation elements. This enables the presentation to be grouped in such a way that the presenter can change the topic and move onto the next most relevant presentation element without having to proceed through each of the presentation elements in between (which may no longer be of interest to the audience. Such ability to skip presentation elements of the sequence makes the display of the presentation appear more professional and faster as well as enabling the presenter to have greater flexibility in being able to change the predetermined sequence of presentation elements during the display of the presentation, namely in real-time.

In one embodiment, the presenter input command receiving engine comprises a gesture interpreter configured to receive gesture commands as the presenter input commands. This is an intuitive way of the user controlling the presentation control device for navigation.

Preferably, the graphical user interface is configured to be switchable between a navigation mode in which the navigation layer is displayed on the presentation control device and a presentation mode in which the current presentation slide is displayed on the presentation control device. This enables the presenter to not only see how to navigate through the sequential presentation but also to see exactly what is being displayed to the audience. With a limited screen size this switching can be particularly useful as in the navigation mode, each presentation element would necessarily be presented as one of a number of small components (icons) on the screen and this would make the single presentation element difficult to read if it needs to be read out to the audience by the presenter. Enabling a presentation mode to be switched to, allows the selected presentation element to be seen in a larger size on the full screen of the presentation control device.

Alternatively or in combination, the graphical user interface can be configured to enable the navigation layer to be overlaid over the current presentation slide displayed on the presentation control device. This is particularly useful if there is a great deal of switching between the navigation mode and the presentation mode or if the presenter is less technically able to execute such switching during the display of the presentation.

In some embodiments, each representation of a presentation element comprises a title summarising the content of the presentation element. This makes the identification of presentation element easier particularly when looking to navigate to a particular presentation element in the sequence of presentation elements, namely when in navigation mode where multiple presentation element icons are displayed on the screen of the presentation control device.

The presentation control device may further comprise a data store for storing a copy of the presentation and for storing a history log of all selections of presentation elements. The navigation layer may be is configured to record each presentation element selection by the presenter in the history log. This is particularly useful when the actual presentation displayed is changed from the predetermined presentation because regardless of what changes are made in real time, a precise copy of the presentation can be recreated from such a history log.

Also, the communications engine can be configured to transmit the history log, or a part thereof, to a remote server for recordal. This enables central recordal of actual navigation and can be used centrally to determine likely trends in navigation of the same presentation by different presenters or even by the same presenter to different audiences. These trends can themselves be used to inform a predicative engine of what the next presentation element is likely to be, and this can help in the more efficient operation of cache management engine for pre-rending presentation elements to be displayed as is described later.

According to another aspect of the present invention there is provided a presentation system comprising a presentation control device as described above and a central server operatively coupled to the presentation control device via a communications network, wherein the communications engine of the presentation control device is configured to transmit the unique identifier of the currently selected presentation element to the central server for provision to presentation device via the communications network.

In some embodiments, the central server comprises a cache management engine which is configured to determine a subset of presentation elements are to be selected for rendering based on the location of the current presentation element being displayed within the navigation layer.

In such an embodiment, the central server may be configured to transmit an identification of the subset of presentation elements selected by the cache management engine to a presentation device via the communications channel, to enable optimised rendering of the subset of presentation elements by the presentation device. The selection of a subset of presentation elements to render, makes the rendering process far more efficient than rendering all of the presentation elements and much faster than rendering presentation elements on-the-fly (in real time as they are selected for display).

Alternatively in some embodiments, the presentation system is configured such that the presentation device operates the presentation screen, wherein the presentation device comprises a cache management engine which is configured to determine a subset of presentation elements to be selected for rendering based on the location of the current presentation element being displayed within the navigation layer. Similarly, this embodiment also makes the rendering process far more efficient than rendering all the presentation elements and much faster than rendering presentation elements on-the-fly.

The cache management engine can be configured to determine members of the subset as being any presentation element most likely to be selected for display next, and the cache management engine determines such members based on: the sequence of presentation elements displayed previously by the presenter navigating the current presentation; the sequence of presentation elements most commonly displayed by the presenter navigating the current presentation; the sequence of presentation elements displayed most recently; or the most typical sequence presentation elements that have been previously displayed, the most typical sequence being determined by reviewing the history of sequences of presentation elements previously displayed.

The cache management engine may be configured to select a subset of the presentation elements of the current presentation for rendering which are located adjacent the location of the current presentation element being displayed within the navigation layer.

In some embodiments, the presentation device comprises a rendering engine which is configured to discard a presentation element which has been rendered but is not part of the subset of the presentation elements determined by the cache management engine. This discarding of rendered elements available for presentation minimises that amount of memory required by the presentation device and prevents the memory being used up by rendered presentation elements which are very unlikely to be required to be displayed again.

Preferably the presentation device is configured to preload media content of any of the presentation elements forming part of the subgroup as determined by the cache management engine. This preloading, for example of embedded links to video for example, can reduce the time lag for display of that presentation element from its selection. In some embodiments, the presentation device is configured to preload media content via a web browser.

In some embodiments the presentation comprises: an assembly data structure, identifying the positional arrangement of each presentation element within the navigation layer; and a content data structure, storing the content of each presentation element, each component of the assembly data structure being associated with component of the content data structure using the unique identifier of each presentation element. This bifurcation of the content of each presentation element from the arrangement of presentation elements makes the handling of the presentation in terms of variations to the predetermined sequence much easier and faster. The order of display of presentation elements can be varied simply by changes to the assembly data structure without changing the content data structure, for example.

In some embodiments, the presentation device is preloaded with a copy of the presentation in unrendered form. In this case, the presentation control device may be configured to transmit changes in the predetermined default sequence to the assembly data structure and changes in the content of a presentation element to the content data structure.

The system may further comprise a document generator configured to use the history log to generate an electronic document comprising the presentation elements in the order in which they were displayed in the presentation.

In some embodiments, the system further comprises an environment actuator and an environmental control device provided to change a characteristic of the environment at a presentation location. The presentation control device is preferably configured to send a command to the environmental control device to control the environment actuator to change the characteristic of the environment of the presentation, the command being sent when a particular presentation element is displayed on the presentation screen.

The environmental actuator in some embodiments comprises one of the group comprising a light, speaker, smoke machine, air conditioning unit, heater, fan, sprinkler, tap, scent disperser, moving part and an additional presentation screen.

The environmental control device may be configured to deactivate the environment actuator when a different presentation element is displayed on the presentation screen.

According to another aspect of the present invention there is provided a method of controlling the delivery of a presentation to a presentation screen operated by a presentation device, the presentation comprising a plurality of presentation elements which are each to be displayed individually in a sequence on the presentation screen, the method comprising: providing a navigation layer enabling a presenter to select a current presentation element to be displayed, the navigation layer including a representation of each of the presentation elements arranged to show a predetermined default sequence in which each of the presentation elements are to be displayed on the presentation screen, each presentation element having a unique identifier and each representation being linked to a specific one of the presentation elements by the unique identifier; receiving a presenter input command and operating with the navigation layer to enable selection of a specific representation for display during a presentation, wherein navigation layer is configured to enable selection of the current presentation element which changes the predetermined default sequence; and transmitting the unique identifier of the currently selected presentation element for display on the presentation screen.

According to another aspect of the present invention there is provided a presentation control device for controlling the delivery of a presentation to a presentation screen operated by a presentation device, the presentation comprising a plurality of presentation elements which are each to be displayed individually in a sequence on the presentation screen, the presentation control device comprising: a graphical user interface providing a navigation layer configured as a two dimensional grid of presentation element representations to enable a presenter to select a current presentation element to be displayed and to navigate to a next presentation element to be displayed by use of gesture commands in orthogonal directions of the two-dimensional grid; each presentation element having a unique identifier and each representation being linked to a specific one of the presentation elements using the unique identifier; and a communications engine for transmitting the unique identifier of the currently selected presentation element for display on the presentation screen.

According to another aspect of the present invention there is provided a system for managing processing resources during display of a presentation comprising a plurality of presentation elements which are each to be displayed individually in a sequence on the presentation screen, the system comprising: a cache management engine which is configured to receive positional information of a current selected presentation element within a two-dimensional grid of representations of presentation elements; the cache management engine being configured to determine a subset of the presentation elements which are to be selected for rendering based the relative proximity of the representation of the current presentation element with the positions of other representations of presentations elements within the two-dimensional grid; and a communications engine for providing identifiers of the subset of presentation elements to a rendering engine for rendering each of the presentations elements within the subset.

According to another aspect of the present invention there is provided a method of managing processing resources during display of a presentation comprising a plurality of presentation elements which are each to be displayed individually in a sequence on the presentation screen, the method comprising: receiving positional information of a current selected presentation element within a two-dimensional grid of representations of presentation elements; determining a subset of the presentation elements which are to be selected for rendering based the relative proximity of the representation of the current presentation element with the positions of other representations of presentations elements within the two-dimensional grid; and providing identifiers of the subset of presentation elements to a rendering engine for rendering each of the presentations elements within the subset.

According to another aspect of the present invention there is provided a system for managing processing resources during display of a presentation comprising a plurality of presentation elements which are each to be displayed individually in a sequence on the presentation screen, the system comprising: a cache management engine which is configured to receive positional information of a current selected presentation element within a two-dimensional grid of representations of presentation elements; the cache management engine being configured to determine a subset of the presentation elements which are to be selected for rendering based the relative proximity of the representation of the current presentation element with the positions of other representations of presentations elements within the two-dimensional grid; and a communications engine for providing identifiers of the subset of presentation elements to a rendering engine for rendering each of the presentations elements within the subset.

According to another aspect of the present invention there is provided a method of managing processing resources during display of a presentation comprising a plurality of presentation elements which are each to be displayed individually in a sequence on the presentation screen, the method comprising: receiving positional information of a current selected presentation element within a two-dimensional grid of representations of presentation elements; determining a subset of the presentation elements which are to be selected for rendering based the relative proximity of the representation of the current presentation element with the positions of other representations of presentations elements within the two-dimensional grid; and providing identifiers of the subset of presentation elements to a rendering engine for rendering each of the presentations elements within the subset.

According to another aspect of the present invention there is provided a presentation system for altering a predetermined presentation for display on a presentation screen, the presentation comprising a plurality of presentation elements which are each to be displayed individually in a predetermined default sequence on the presentation screen, the presentation system comprising: a data store for storing an assembly data structure that identifies the positional arrangement of each presentation element within a two-dimensional array; and a content data structure, storing the content of each presentation element, each component of the assembly data structure being associated with component of the content data structure using a unique identifier of each presentation element; a receiver for receiving data indicating changes in the predetermined default sequence to the assembly data structure and/or changes in the content of a presentation element to the content data structure; and a processor for altering the assembly data structure to accommodate any changes in the positional arrangement of presentation elements and for altering the content data structure for any changes to the content of a presentation element.

According to another aspect of the present invention there is provided a method of altering a predetermined presentation for display on a presentation screen, the presentation comprising a plurality of presentation elements which are each to be displayed individually in a predetermined default sequence on the presentation screen, the method comprising: storing an assembly data structure that identifies the positional arrangement of each presentation element within a two-dimensional array; storing a content data structure, storing the content of each presentation element, each component of the assembly data structure being associated with component of the content data structure using a unique identifier of each presentation element; receiving data indicating changes in the predetermined default sequence to the assembly data structure and/or changes in the content of a presentation element to the content data structure; altering the assembly data structure to accommodate any changes in the positional arrangement of presentation elements; and altering the content data structure for any changes to the content of a presentation element.

According to another aspect of the present invention there is provided a presentation system for presenting a predetermined presentation on a presentation screen, the presentation comprising a plurality of presentation elements which are each to be displayed individually in a predetermined default sequence on the presentation screen, the presentation system comprising: an environmental actuator for altering a characteristic of a presentation environment in which the presentation screen is provided; and an environmental control device configured to control the environment actuator to change the characteristic of the environment of the presentation; wherein the environmental control device is arranged to receive a command from a presentation control device which is controlling the display of presentation elements on the presentation screen, the command being received when a particular presentation element, requiring the change in the environment characteristic, is displayed on the presentation screen.

According to another aspect of the present invention there is provided a method of presenting a predetermined presentation on a presentation screen, the presentation comprising a plurality of presentation elements which are each to be displayed individually in a predetermined default sequence on the presentation screen, the method comprising: accessing an environmental actuator for altering a characteristic of a presentation environment at a location in which the presentation screen is located; receiving a command from a presentation control device which is controlling the display of presentation elements on the presentation screen, the command being received when a particular presentation element requiring the change in the environment characteristic is displayed on the presentation screen; sing an environmental control device to control the environment actuator to change the characteristic of the environment of the presentation in accordance with the command.

### BRIEF DESCRIPTION OF THE FIGURES

Specific embodiments of the invention will now be described, by way of example, with reference to the accompanying drawings, or which:

FIG. 1 is a schematic block diagram showing a system for facilitating the delivery of a presentation by one navigator to many audience members, in accordance with an exemplary embodiment;

FIG. 1A is an image showing an example presentation slide;

FIG. 1B is a schematic block diagram showing a navigation layer provided on a presentation control device of the system shown in FIG. 1;

FIG. 2 is an image showing a representation of how the navigation layer of FIG. 1B may appear to the navigator on the presentation control device;

FIG. 2A is a block diagram showing how slides, with unique references, may be arranged in the navigation layer of FIG. 1B;

FIG. 3 is a schematic block diagram of the presentation control device of the system shown in FIG. 1;

FIG. 3A is a schematic block diagram showing a first example rendering pattern of slides in the navigation layer of FIG. 1B, with the slides shaded in black representing rendered slides and the slide with a striped border representing the slide currently being displayed on the presentation screen;

FIG. 3B is a schematic block diagram showing a second example rendering pattern of slides in the navigation layer of FIG. 1B, with slides shaded in black representing rendered slides, slides shaded in grey representing slides that are not rendered and a slide with a striped border representing the slide currently being displayed on the presentation screen;

FIG. 3C is a schematic block diagram showing a third example rendering pattern of slides in the navigation layer of FIG. 1B, with slides shaded in black representing rendered slides, slides shaded in grey representing slides that are not rendered and a slide with a striped border representing the slide currently being displayed on the presentation screen;

FIG. 3D is a schematic block diagram showing a fourth example rendering pattern of slides in the navigation layer of FIG. 1B, with slides shaded in black representing rendered slides, slides shaded in grey representing slides that are not rendered and a slide with a striped border representing the slide currently being displayed on the presentation screen;

FIG. 3E is a schematic block diagram showing a fifth example rendering pattern of slides in the navigation layer of FIG. 1B, with slides shaded in black representing rendered slides, slides shaded in grey representing slides that are not rendered and a slide with a striped border representing the slide currently being displayed on the presentation screen;

FIG. 3F is a schematic block diagram showing a sixth example rendering pattern of slides in the navigation layer of FIG. 1B, with slides shaded in black representing rendered slides, slides shaded in grey representing slides that are not rendered and a slide with a striped border representing the slide currently being displayed on the presentation screen;

FIG. 4 is a flow diagram showing an example method of storing data relating to which slide has been displayed in a data store, in accordance with an aspect of the present embodiment;

FIG. 5 is a flow diagram showing an example method of determining whether to render a slide, in accordance with an aspect of the present embodiment;

FIG. 6 is a flow diagram showing an example method of pre-loading media relating to slide most likely to be displayed next, in accordance with an aspect of the present embodiment;

FIG. 7 is a schematic block diagram showing a system for facilitating the delivery of a presentation by one navigator to many audience members in different locations, in accordance with an exemplary embodiment; and

FIG. 8 is a schematic block diagram showing a system for facilitating the delivery of a presentation by one navigator an audience within a controlled environment, in accordance with an exemplary embodiment.

### DETAILED DESCRIPTION OF EXEMPLARY EMBODIMENTS

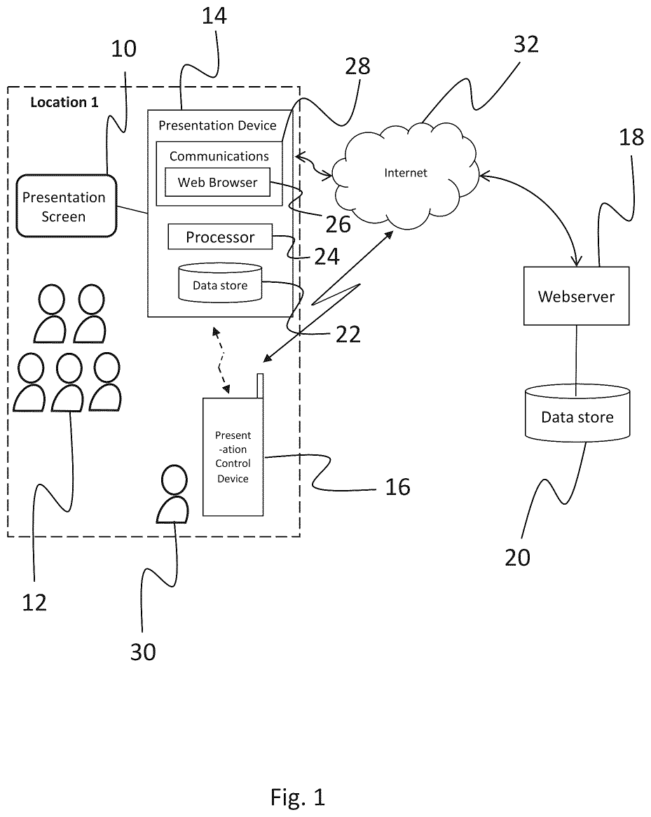

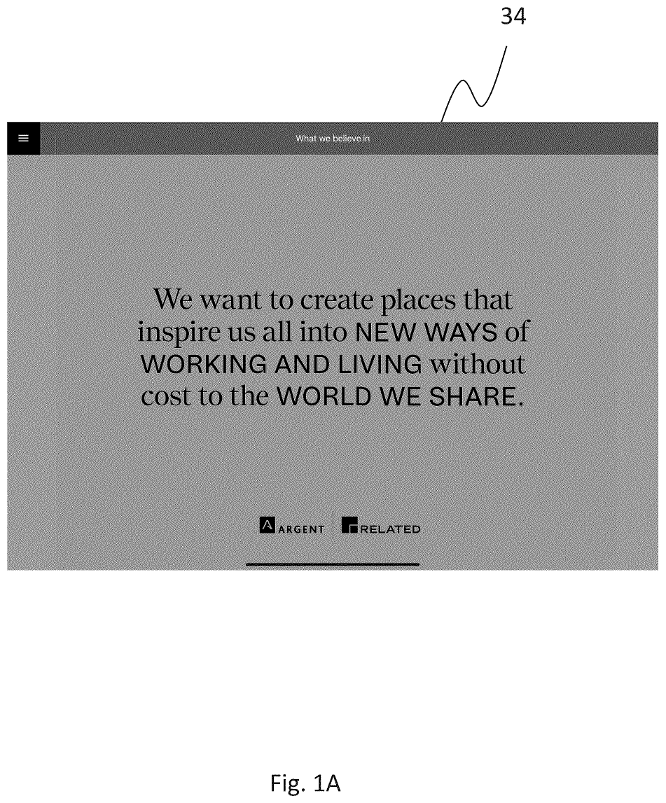

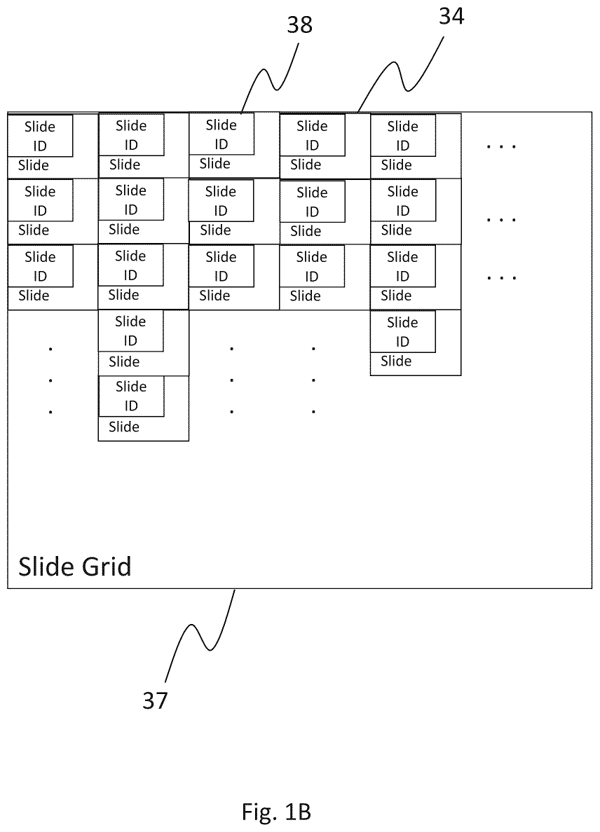

The present invention can be embodied in a presentation system that can operate in several different ways and accordingly a system which can be configured to operate in each of those different ways. One example of such a presentation system is shown in FIG. 1. The presentation system of FIG. 1 comprises a presentation screen 10 at a given location (Location 1 in this embodiment) which is viewed by an audience 12 present at Location 1. The system also comprises a presentation device 14, a presentation control device 16 and a webserver 18 with its associated data store 20.

The presentation screen 10 is controlled by the presentation device 14, also present at Location 1, which generates the signals to drive the presentation screen 10 and display a presentation. This presentation can be in any form with multiple slides or pages, but which is in this example, a Microsoft PowerPoint™ slide presentation. (Other examples include: Google Slides™, Prezi™ presentations, Canava™ presentations, Ludas™ presentations, Powtoon™ presentations etc.). The presentation is, in one embodiment, stored locally in a data store 22 of the presentation device 14 and is provided to the presentation screen 10 under the control of a processor 24. In other embodiments, the presentation can be obtained, on demand, from the webserver 18 in a similar manner to the provision of website pages to a browser 26.

The presentation is obtained from a remote webserver 18, which also has a copy of the presentation stored within its local data store 20, via one of two different routes. In one embodiment, the presentation is obtained directly by the presentation device 14 using a web browser 26 in its communications engine 28. In another alternative embodiment, the presentation can be provided to the presentation device 14 from a presentation control device 16 via a local (typically wireless) communications link (such as Bluetooth or WiFi). Here the presentation control device 16 obtains the presentation (or at least a relevant part of it) from the webserver 18 (typically using a web browser 26) and then relays this to the communications engine 28 of the presentation device 14 via the local wireless link. The presentation (or at least the part that has been obtained) is then stored in the data store 22 of the presentation device 14 ready to be used to provide the presentation to the presentation screen 10. Also, the data to be displayed within a presentation which may be accessible via any links embedded with the presentation, such a link to video content, can be accessed and downloaded in advance of the presentation being run and displayed on the presentation screen 10. This can be done for the whole presentation which requires more resources to be available on the presentation device 14 and more set up time, or for a portion of the presentation which is about to be displayed, namely the next slide or set of likely slides. This preloading of content in one embodiment enables the presentation to not suffer any delays in terms of content provision which may otherwise be caused by data bottleneck over the communications channels between the web server 18 and the presentation device 14.

As mentioned above in some embodiments, the media content of the presentation is provided from the webserver 18 by being loaded on-demand (as any traditional website does). This on-demand nature of provision of such media means that the latency of the communications network has the potential to affect the quality of the presentation provided. To avoid lagging and other delays in the smooth display of the presentation several embodiments of the present invention utilise techniques to mitigate the amount of information being transmitted across the communications networks, thereby mitigating the potential communications bottleneck problems. Similarly, in the embodiment where the presentation is stored locally, the rendering of all of the presentational elements (slides) can present a significant processing burden as can rendering each slide on the fly as it is displayed. The processing burden can slow down a presentation and cause lagging effects for example. In such cases managing the slides which are pre-rendered can have significant benefits in preventing such lagging or processing demand peaks. These techniques are described later.

The presentation control device 16 is a device used by a person (presenter) 30 in control of the presentation. The presentation device 16 enables the presenter to select how the presentation is to be displayed to the presentation screen 10 and, in particular, enables the presenter to choose the presentation order of slides which may be different to the predetermined order set out in the original presentation. Importantly, the presentation control device 16 enables the presenter 30 to change the order of presentation of the slides of a presentation in real time, namely as the presentation is being given and with consummate ease. This is possible because of the two-dimensional user interface (hereinafter referred to as the ‘two-dimensional grid layout’) provided on the presentation control device 16 and because each element of a presentation, namely each slide, has a unique identifier and so is uniquely addressable and selectable. In other embodiments, the presentation control device 16 can also control the environment in which the presentation is being provided and/or enable control of a plurality of presentations being given in different locations (both of which are described in detail later).

The embodiments of the present system comprise a plurality of features that may operate independently of one another or in combination with other features, each of which is explained in detail below.

These features include:

A Two-Dimensional Grid Layout
The two-dimensional grid layout provided on the presentation control device 16 includes slides 34 organised into a two-dimensional grid that allows the presenter 30 of the system to follow a traditional “linear” (sequential) presentation path but also to move in different directions (non-linear path) through the set of slides 34. The two-dimensional grid layout and its operation is described in detail later.

A Navigation Layer
The two-dimensional grid layout noted above allows the presenter 30 to use gesture commands to navigate through to different slides 34 presented in the grid. For example, during a presentation the presenter 30 can move forward and back through the grid by swiping up/down and move horizontally through the grid by swiping left/right. Such functionality allows a user to move more quickly between thematic topics (e.g., swiping right may move from an introduction theme to a specific topic theme). Here, slides 34 relevant to each thematic topic can be arranged in groups taking the form of different columns in the grid, such that movement from one column to the next causes a change from one thematic group of slides to the next. For further control over the content of the presentation, the navigation layer may be configured to enable the presenter 30 to transition between different display modes on the presentation device 14. For example, the presentation device 14 can be switched between a presentation mode (in which a current slide is shown) and the navigation mode in which multiple slides 34 in the grid structure are visible (to control navigation through the slide deck).

Content Virtualisation
Rendering slides for presentation requires computer system resources. To improve the impact of the presentation on finite computer system resources, a selected subset of slides may be rendered rather than the entire presentation. The subset can be determined by the current location of the slide in a matrix of slides which is the focus of the presenter's attention and the presenter's navigation from that location to the next slide. This is described in greater detail below.
Analytics-Informed Media Pre-Loading

The likely “next slide” that a presenter will select from the two-dimensional grid may also be predicted and determined according to the sequence of slides displayed during a previous presentation by the same presenter or from commonly selected slides by the same presenter or group of presenters. This knowledge is stored centrally and used to predict the next most likely slides which can then be pre-loaded for presentation, reducing the lag times for on-demand slide presentations as well as rendering of locally stored presentations.

Network Packet Pre-Filtering
In order to mitigate against the sending of large presentation files over a network during a presentation when there are real time changes to the structure of the presentation, an embodiment (a particular configuration of the system) provides a copy of the presentation on startup of the presentation software (running on the presentation device) and then deconstructs the presentation into a data structure which enables changes to a presentation slide being displayed (namely to the predetermined order of the slides in the presentation) can be conveyed by transmitting the changes in order to the data structure over the network. The provision of only the changes to the order, significantly reduces the amount of data that needs to be communicated.

Environmental Effects
The presentation may be integrated with the real-world environment in which the presentation is being delivered. Embodiments of the present invention enable control of the environment such that changes within the presentation can cause a change (e.g., control of an object) in the real world/the location(s) where the presentation is being given. Examples of the type of environmental aspects which can be controlled are lighting, sounds and temperature.

It is noted that a presentation may be controlled by the presenter 30 themselves or another user who is designated to control the display of slides. These individuals are referred to herein as “the navigator” or “the presenter”.

Each of the above aspects which are provided for by different configurations of the above-described system are now described in greater detail below.

### Presentation View

To help a navigator 30 navigate a complex narrative, for example with numerous slides covering a variety of topics or themes, presentation content is arranged on the presentation control device in a two-dimensional grid. The grid comprises a plurality of columns, each column comprising one or more slides (presentation elements). The various columns may each comprise content relating to a particular theme or topic. For example, a first column might contain introduction slides (e.g., to introduce the speaker, location etc.), a next column may contain overview slides (to summarise the overall content of the presentation) and further columns may contain slides relating to specific topics within the overall presentation.

In use, the navigator 30 uses gesture commands on the presentation control device 16 (e.g., a mobile telecommunications device such as an iPad) to control which presentation element is displayed, for example by swiping left/right on a touch screen of a mobile device (acting as the presentation control device) to traverse different columns of slides and swiping up/down on the touch screen of the mobile device to move through the different slides in a column.

The slide content within the two-dimensional slide grid 37 may be displayed on the mobile device in ‘presentation view’ in which a single slide is presented. Additionally, or alternatively, the slide content is displayed on a further device, such as a presentation screen, which may be viewed by an audience. When the navigator selects a slide by transitioning to that slide using a gesture command, the slide will appear on the display screen of the presentation control device 16 and optionally on the presentation screen 10. An example presentation slide 34 is shown in FIG. 1A.

An application running on the mobile device may keep a log of the slides presented by the navigator 30 (the presentation “history”). By recording the history of the slides shown in this way, a navigator 30 is advantageously able to swipe back from one column within the slide grid 37 to the last shown slide from the previous column (instead of, for example, reverting to either the first slide in the previous column or the last available slide). Accordingly, regardless of the actual order in which the slides are displayed (assuming this changes from the predetermined default sequence of the presentation elements (slides) at the start of a presentation), it will always be possible to traverse or recall that navigation journey using the history log.

The two-dimensional grid format of the slides underlying the visible slide in the presentation view enables the presenter 30 to intuitively swipe to move the presentation on to a slide that may follow the current slide in its column (e.g., by swiping up/down), move to a slide in the next column (e.g., by swiping left) or return to the previous slide (e.g., by swiping right).

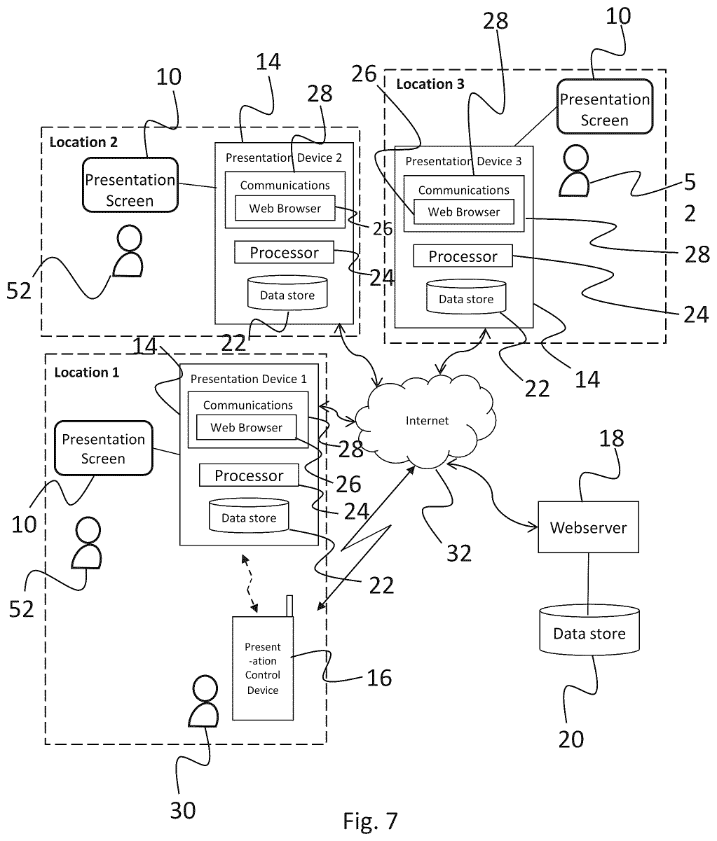

Presentations may take place in one or more of several different contexts: a one-on-one meeting (e.g., in a coffee shop), a one-to-many meeting (e.g., in an office or marketing suite), or with attendees watching the presentation remotely in a web-browser window (one to multiple locations (see FIG. 7 later). An example of a one-to-many meeting with a presenter 30 present is shown in FIG. 1. Here it can be seen that the presenter's presentation control device 16 couples via the internet 32, to the central webserver 18 where the content of the slides is stored in the data store 20. The content to be displayed is provided to the viewing audience at Location 1, via the presentation device 14 which obtains the presentation slides from the webserver 18 via its browser 26 and provides them to the presentation screen 10. An individual viewing the presentation in any such manner is hereinafter referred to as the viewer.

FIG. 1 also shows an alternative/additional configuration of the system which is represented by the dashed line between the presentation control device 16 and the presentation device 14. Here the selection by the presenter 30 of the next slide is communicated from the presentation control device 16 directly to the presentation device(s) 14 and, in the configuration where the presentation is provided in an on-demand basis, the browser 26 is instructed to retrieve the next slide as a new browser page.

### Navigation Layer

As explained above, the two-dimensional grid layout allows a navigator 30 to move between adjacent slides. To allow slides to be skipped such that a presentation is more configurable “on the fly”, the presentation system may be further enhanced using a navigation layer 36.

As noted above, the slides may be arranged in a two-dimensional grid format. This concept is illustrated in FIG. 1B. As shown in FIG. 1B, each slide 34 has its own unique identifier 38. This grid format may be thought of as a layer underlying the presentation layer of the presentation system.

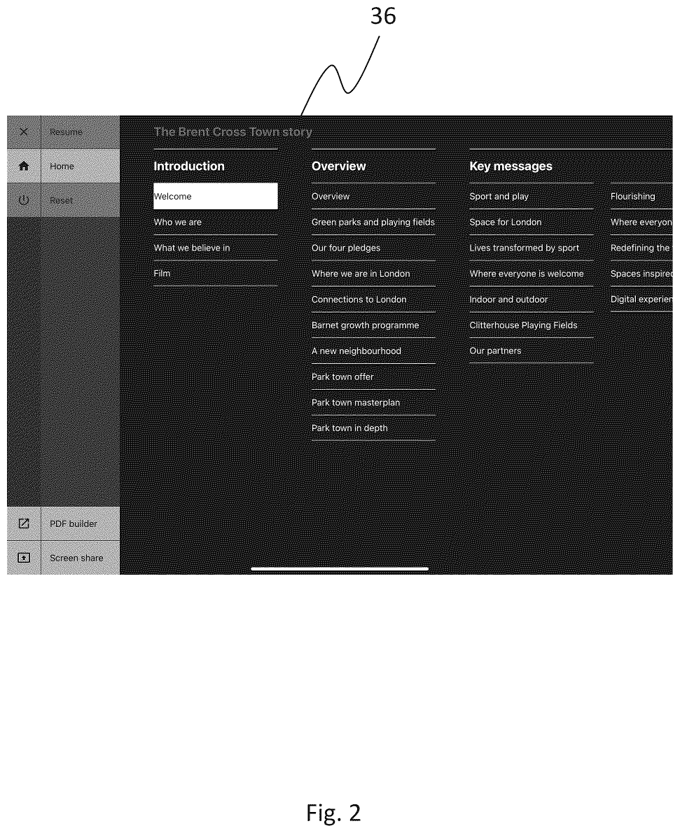

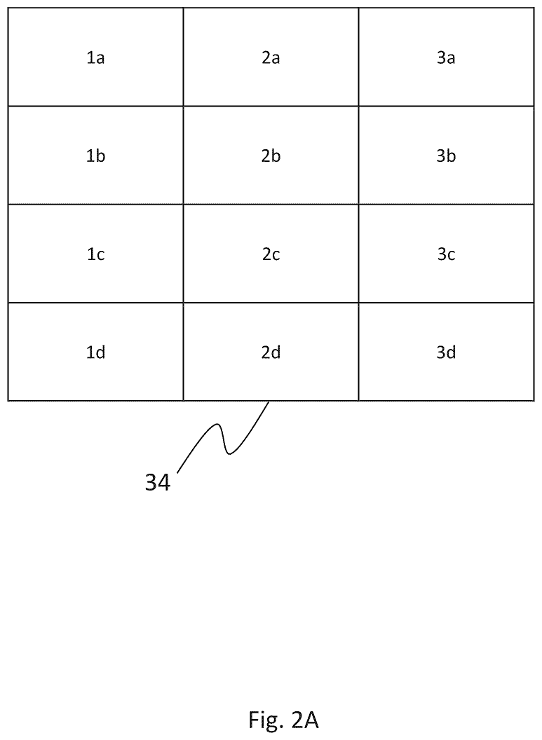

As provided by the presentation system according to the present embodiment, the navigation layer 36 provides the navigator 30 with an interface that allows them to effectively see the grid format of FIG. 1B. The navigation layer 36 is provided in the presentation control device 16 as part of a slide selector module (part of the application running on the presentation control device 16). The navigator 30 is therefore able to change between a presentation view where they can view the slides as the viewer 12 would see them on the presentation screen 10 (optionally with the addition of some contextually relevant slide manipulation controls, e.g., gallery buttons, speaker notes) and a navigation layer 36 view. The navigation layer 36 is in one embodiment superimposed on the content of the presentation for the navigator 30. FIG. 2 shows a representation of how the navigation layer 36 may appear to the navigator 30. It is noted that the grid format of FIG. 1B and the navigation layer 36 view of FIG. 2 are effectively showing the same content, just in a different visual format.

The navigation layer 36 shows a condensed representation of the full presentation structure. For example, as illustrated in FIG. 2, the navigation layer 36 may show a plurality of columns (which represent themes or topics) laid out in a horizontally scrolling format, with slides 34 that fall under the respective theme or topic running down each column as rows. By arranging slides 34 in columns according to themes or topics, it is easier for the navigator 30 to locate specific slides and navigate between them in a non-predetermined manner. Each slide 34 may be represented in the navigation layer 36 by a title that summarises the content of that slide. The slides 34 referred to in the navigation layer 36 correspond to the slides 34 available to be displayed in the presentation view and are referenced via their unique identifiers 38.

Columns are also grouped together to cover larger themes or topics in this embodiment. For example, in a presentation about hobbies, there may be a column with slides about hockey, a column with slides about tennis and a column with slides about the piano. The columns relating to hockey and tennis can further be grouped together as a “bucket” since they both relate to sport. A further subheading may appear over these columns to indicate they both relate to sport.

The navigation layer 36 allows a presenter 30 to move from one slide 34 to any another slide 34 (i.e., not just the adjacent slide in the two-dimensional grid but any slide 34 of the presentation), breaking out of the prescribed running order of the presentation (the default slide sequence). The navigator 30 may select a slide 34 from the navigation layer 36 to be displayed to the viewer 12. For example, the navigator 30 may choose a slide 34 in a different category (column in the two-dimensional grid) to the on-screen slide to be displayed next by selecting this slide 34 in the navigation layer 36. Since the navigation layer 36 is not visible to the viewer 12, it will appear to the viewer 12 that the presentation has transitioned seamlessly to the next slide 34, whereas, in fact, the navigator 30 had selected a slide 34 that would not have been next in the default slide sequence.

By default, the presentation may start by displaying to the viewer 12 the slide 34 in the first row of the first column (i.e., slide 1a when a number indicates a column and a letter indicates a row, as indicated in FIG. 2A), transition to the slide 34 in each subsequent row (1b, 1c . . . etc.) and then progress through each column and row in turn (e.g., 2a to 2d followed by 3a to 3c). However, as described above, the navigator 30 may select a slide 34 in any column and row of the two-dimensional grid to be displayed next, not necessarily the adjacent slide 34. For example, the navigator 30 may select for the presentation to start at slide 1b, transition to slide 2b and subsequently transition to 2c.

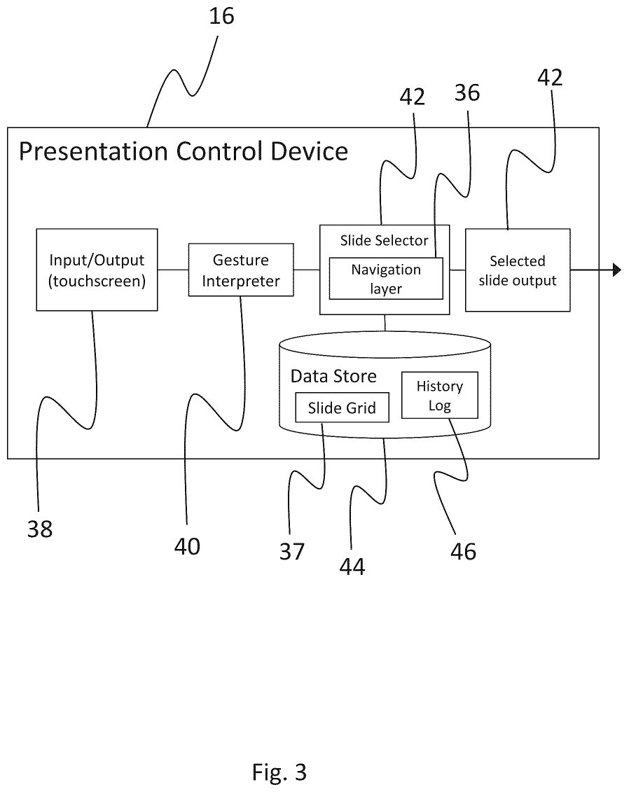

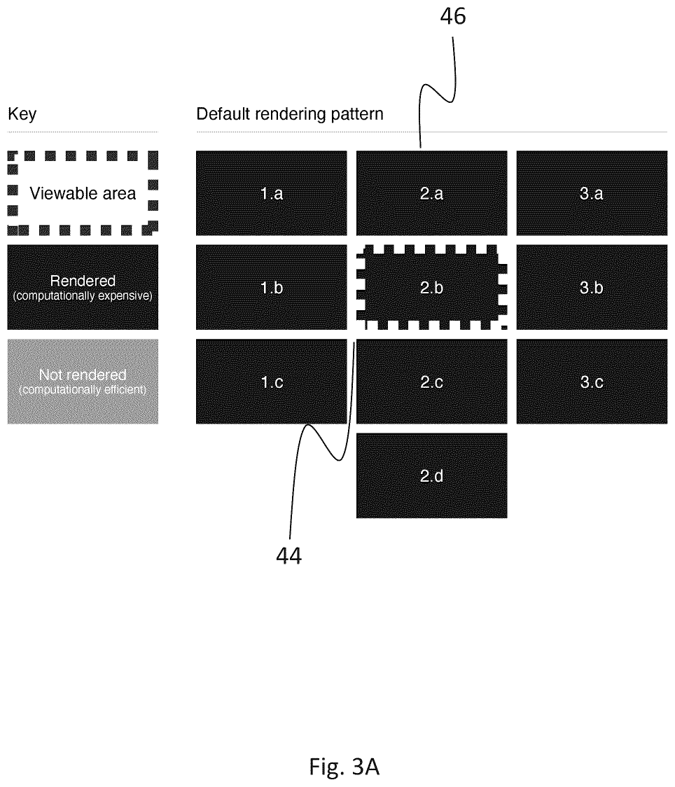

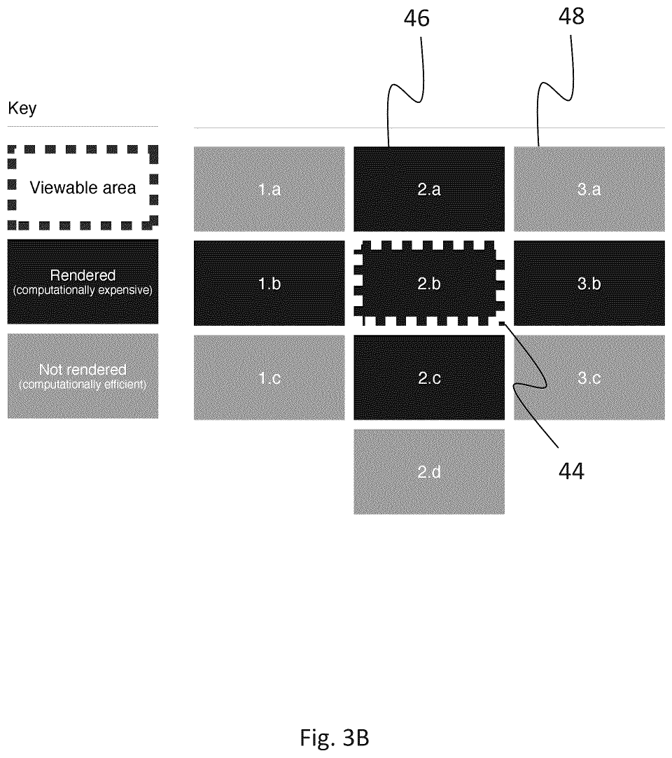

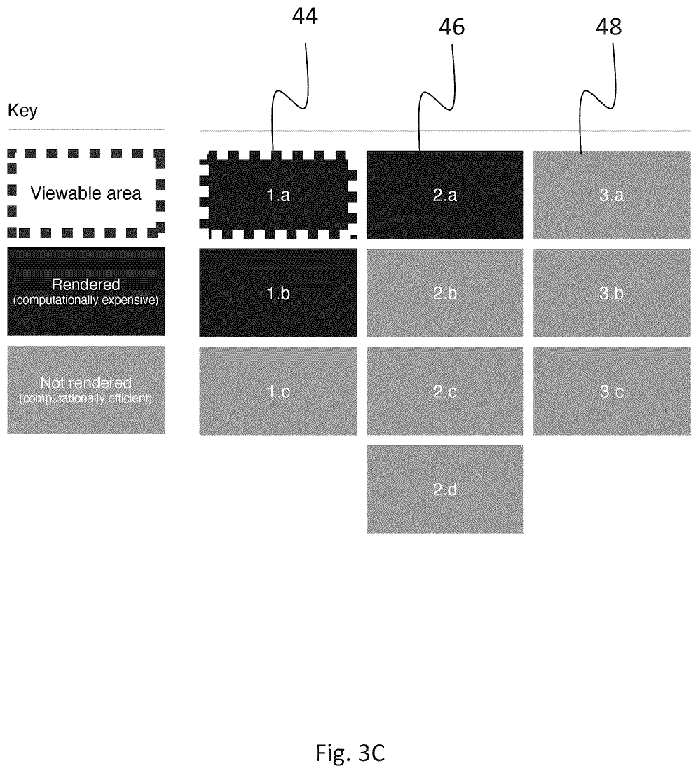

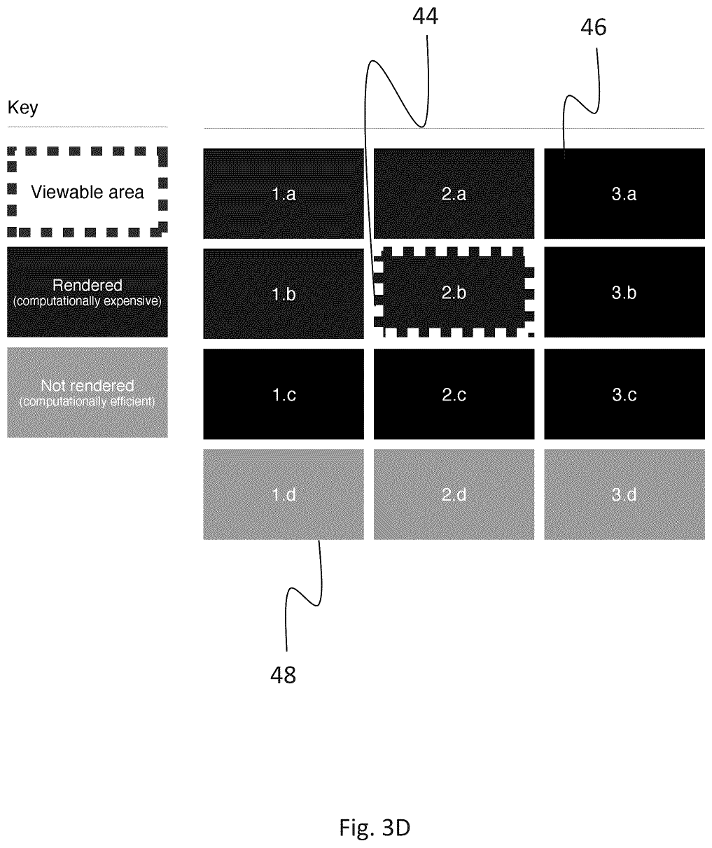

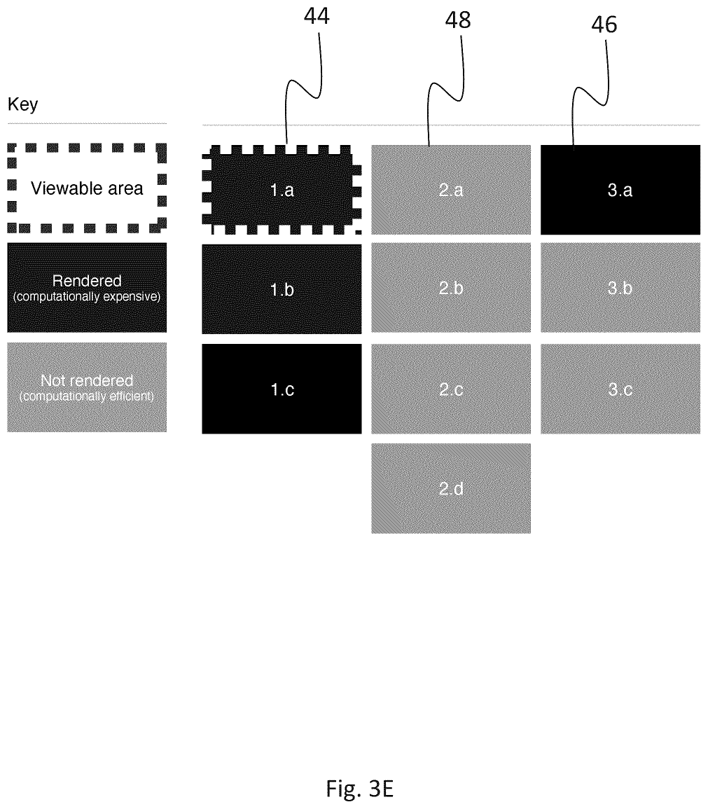

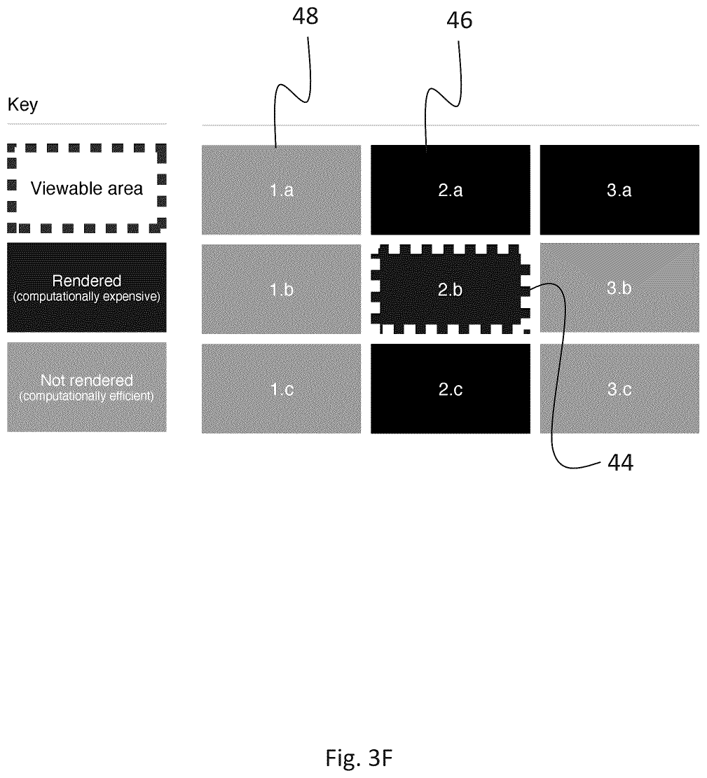

FIG. 3 shows the presentation control device 16, which includes an input/output 38 (e.g., touchscreen), gesture interpreter 40, slide selector 42 and a data store 44 with data relating to the slide grid 37 and a history log 46 (e.g., specifying previously shown slides). The slide selector module 42 takes gestures interpreted by the gesture interpreter 40 of the device and uses them to select the next slide 42. When the navigator 30 is in the presentation view, the next slide to be displayed is determined based on the gesture command (e.g., direction of the swipe), the position of the current slide in the two-dimensional grid and the adjacent slides in the two-dimensional grid. When the navigator 30 is in the navigation view, the next slide to be displayed is determined by the unique identifier 38 of whichever slide 34 the user has selected from the columns of slides in the navigation view (shown in FIGS. 113 and 2). This can be any slide 34 of the presentation from any column. The navigation view therefore enables the presentation content to be modified on the fly without it disturbing the audience's viewing experience.

### Content Virtualisation

Content virtualisation is the concept of only rendering a portion of the grid of slides, such as slides that are likely to be displayed next. The number of elements that are rendered is a small subset of all available elements. For example, slides which are immediately adjacent the slide currently being displayed within the two-dimensional grid may be rendered.

These slides 34 may not be visible to the navigator 30 selecting slides 34 from the two-dimensional grid in the presentation view. However, by rendering a subset of slides 34 that are not visible, when a swipe gesture is started, the content has already been rendered and can be transitioned into view without additional processing being required.

This reduction in rendered elements lowers the overall impact on system resources (e.g., processing power and memory consumption), making those resources available to the content that is displayed to the viewer. This improves the quality of the user experience for the navigator 30: by lowering the overall impact on system resources, processing power and memory are reserved for visible content, which in turn leads to a higher frame rate when drawing content to the display. Testing across a wide variety of devices indicated a significant improvement in frame rate, delivering animations and effects at 60 frames per second rather than 15-20 frames per second (24-30 frames per second being the minimum amount required for fluid movement). This improvement can lead to higher quality presentations being presented.

The choice of which non-visible slides to render may be configurable by the navigator 30 and/or may be determined by analytics-informed media preloading as discussed below. For example, the on-screen slide will be rendered, and any adjacent slides in the two-dimensional content grid may be rendered. If the navigator 30 can move up and down the slide columns shown in FIG. 2A and left and right between columns, a total of 5 slides may be rendered—the currently visible slide and the four slides which are above, below, to the left and to the right of the current slide in the grid). In alternative arrangements, the previously displayed slide may be rendered and/or the slide most likely to be displayed next may be rendered (discussed in more detail below). Slides may be rendered to the screen as HTML elements when operating in the on-demand configuration.

FIGS. 3a to 3f show example representations of the two-dimensional grid that indicate which slides may be rendered. As shown by the key, a hashed border 44 indicates the slide currently being displayed to the viewer, slides shaded in black 46 show rendered slides and slides shaded in grey 48 show slides which have not been rendered.

FIG. 3a shows a rendering pattern where all slides within the grid have been rendered. This rendering pattern would allow a navigator to transition seamlessly to any slide in the two-dimensional grid but would be computationally expensive.

FIG. 3b shows an example rendering pattern where the slide currently being presented (slide 2b) has been rendered, along with its adjacent slides in the two-dimensional grid. For example,

FIG. 3b shows the slide in the same column but row above the current slide rendered, the slide in the same column but row below the current slide rendered and the slides adjacent to the current slide in neighbouring columns rendered. This allows the presentation to seamlessly transition from the current slide (slide 2b), move on to the next slide selected by the navigator (slide 2c) and, if need be, revert to the slide shown previously (slide 1b) since each of these slides have been rendered.

It is efficient to render the adjacent slides to the on-screen (current) slide in the two-dimensional grid because of the way the slides are organised. Since columns are arranged in the grid according to theme or topic, and the rows (from top to bottom) are arranged in order of a default sequence, it is likely that the next slide desired to be displayed is the slide in the row directly below the on-screen slide or the slide in the adjacent column. It is also often desirable during a presentation to transition to the slide that precedes a particular slide, for example to answer a question relating to that slide or to provide further detail on a topic. The system may therefore be configured such that the slides in columns adjacent to the on-screen slide and the previous on-screen slide are rendered and the remaining slides which are not likely to be displayed next are not rendered.

If there is no adjacent slide in the next column (e.g., if slide 2d is the current slide), then the first slide in the next column may be rendered (e.g., slide 3a in FIG. 3b).

Similarly, if there is no adjacent slide in the previous column, then the last displayed slide from the previous column may be rendered. For example, if the navigator had shown slides 1a and 1b from column 1, then slide 1b may remain rendered as the current slide changes to slide 2c and then 2d. In such an arrangement, if the navigator is on slide 2c or 2d in presentation mode, then swiping back to column 1 would bring up the already rendered slide 1b.

FIG. 3c shows another example of a rendering pattern where slides 1a, 1b and 2a have been rendered.

FIG. 3d shows a further example of a rendering pattern, where slides 1a to 1c, 2a to 2c and 3a to 3c have been rendered. The user may navigate to any slide within the rendered grid, such as up and down and across the columns, as well as diagonal movements (e.g., from 2b to 3a).

It is also possible to “switch off” certain columns (i.e., not render specific columns). For example, as shown in FIG. 3e, column 2 is “switched off”. No slide in column 2 is rendered but the adjacent slides (i.e., the slide below the current slide and the slide to the right of the current slide, missing out column 2) are rendered. It is noted that although the slides in column 2 are not rendered in this arrangement they would still be accessible to the navigator via the navigation layer.

FIG. 3f shows a further rendering pattern example where the previously displayed slide is rendered (slide 2a), the next slide expected to be displayed is rendered (slide 2c) and the first slide in the adjacent column is rendered (slide 3a).

Any slide in the two-dimensional grid may be rendered.

It is noted that as the navigator moves through the presentation the subset of rendered slides changes, with slides that are no longer classed as “adjacent” to the currently presented slide being dropped from the set of rendered slides and newly adjacent slides being rendered in their place.

Analytics-Informed Media Preloading

In a further embodiment, the likely next slide may be determined according to the sequence of slides displayed by this particular navigator (presenter) when the same presentation had been last presented. This particular sequence is taken from the history log in the presentation control device which is uploaded to the webserver once the previous presentation concluded. Alternatively, the likely next slide may be determined based on data from previous presentations (e.g., the most common slide sequence). Once again, this data is obtained from the history logs of previous presentations and then analysed to determine statistical measures such as mode (most frequently used slide).

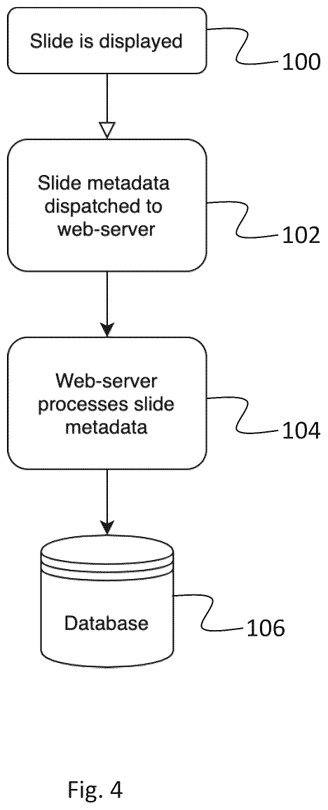

The process of storing slide related data to, for example, determine the previously displayed slide or the slide displayed next by this particular navigator when the same presentation had been displayed previously is shown in FIG. 4. Once a slide is displayed at Step 100, Metadata relating to the slide being displayed is dispatched to the webserver at Step 102, processed at Step 104, and then transmitted to a database in the data store at Step 106 where it is stored.

As soon as the navigator 30 moves to a new slide, this is displayed on the presentation screen 10 and there is a high likelihood that it is a slide of the subset of slides that has already been rendered. If not, the slide will be rendered on the spot. Once a new slide is presented, the new set of slides to be rendered is determined. Any rendered slides which are not part of this new set are discarded (no longer rendered) and any non-rendered slides that are now part of this new set are rendered.

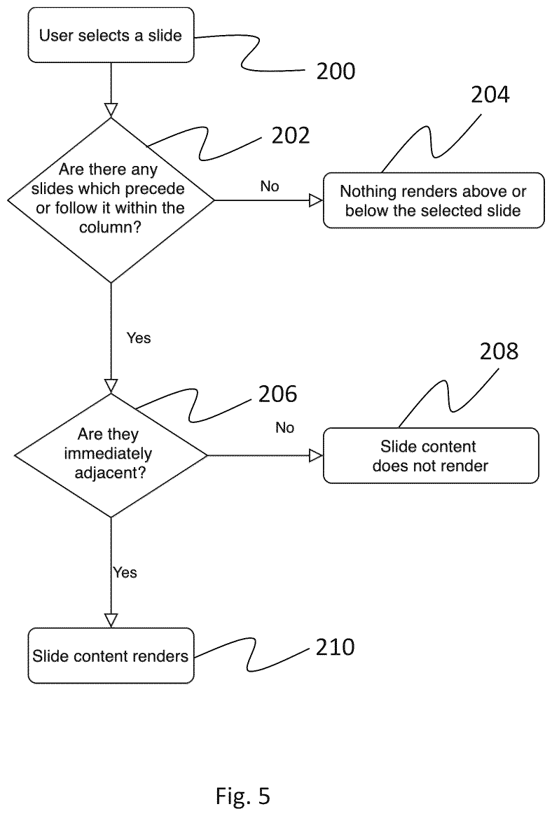

This process may be carried out by a cache management engine (not shown) at the webserver 18 or at the presentation device 14, which determines the on-screen slide, selects the subset of slides to be rendered in anticipation of the slide that is likely to be displayed next and discards from the subset any previously rendered slides which are not likely to be displayed next. A rendering engine (not shown) at the presentation device 14, may be used to render the appropriate slides once the subset of slides has been either communicated to or determined at the presentation device 14. An example of this process is illustrated in FIG. 5.

At Step 200 a user selects slides. At Step 202 the system determines whether there are any slides which precede it or follow it within the column. If no slides precede it or follow it, at Step 204 no slides are rendered. If there are slides which precede or follow the selected slides, at Step 206 the system determines whether the slides are immediately adjacent the selected slide. If the slides are not immediately adjacent the selected slide, at Step 208 the slide content is not rendered. If slides are determined to be immediately adjacent the selected slide, at Step 210, the slide content is rendered.

Data indicating which slides have been displayed during a particular presentation may be recorded in a database. This data can be used to generate a document (such as a pdf) showing the displayed slides. This, for example, enables a presenter to immediately distribute slide handouts of the presentation shown, even if the content of the presentation had been modified on the fly (i.e., while the presentation was taking place).

When a presentation is shared with a remotely connected viewer, media content is loaded on-demand via a webserver (as any traditional website does). Once the on-screen media has finished loading, the server begins preloading media according to what is likely to be shown next. For example, in a linear format, when viewing slide number 6, the system may determine to next preload media for slide number 7. The application's non-linear format means that an adjacent slide (e.g., the below slide in the current column, or the slide to the right of the current slide (in the adjacent column)) may in some cases not be the most-probable next slide.

In this embodiment, the behaviour of previously delivered presentations is recorded, namely, the order in which slides are presented, time spent on each slide, and any actions taken within the context of a slide. This allows the system to make a probabilistic prediction as to what the next most likely action is. Using this predictive data, it is possible for the system to generate a graph of most probable next slides and start to load any media content (images and video) ahead of when it is required. Such a probabilistic determination can be made by a prediction engine (not shown), which is part of a cache management engine (not shown), provided at the webserver 18 which uses an analytic database 50.

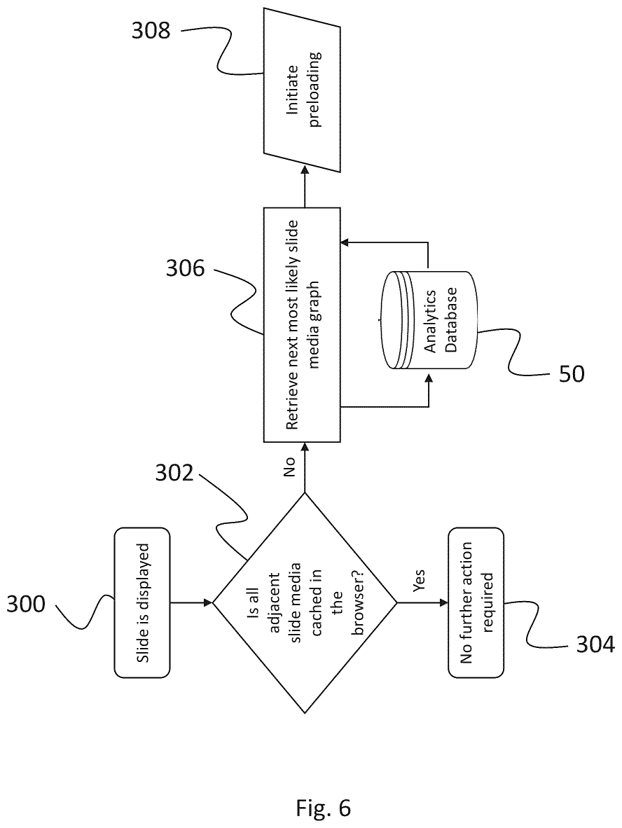

FIG. 6 shows an example flow-chart of this process.

At Step 300 a slide is displayed. The system will then determine, at Step 302, whether all adjacent slide media is cached in the browser. If it is, at Step 304, no further action is required. If it is not, at Step 306, the system will retrieve the next most likely slide media graph and determine, using an analytics database 50, the most likely next slide. Once determined, at Step 308, the media content of the most likely next slide is pre-loaded.

### Network Packet Pre-Filtering

The presentation system according to another embodiment may be provided by a presentation software application (not shown) operating on the presentation control device 16 that may share presentation content to remote clients 52 connected over the communications network as shown in FIG. 7. The navigator 30 and each connected viewer 52 (at Locations 1, 2 and 3) may run a presentation application on their respective computer systems (presentation devices 14) to display the presentation on their respective presentation screens 10.

Media (e.g., images and video) may be loaded from the nearest networked computer, which in some cases (for the presenter/navigator 30, or in a marketing suite) may be the navigator's presentation device 14 itself as shown by the dashed arrow in FIG. 7. The navigator/presenter 30 never sends media content over the network—instead packets of references/pointers are sent to the presentation devices 14 which represent the changes made to the application state of the presentation on the presentation control device 16. The application state is a complete representation of all the variables' values within the application at one point in time. For example, the selected slide within a column is represented in the application state by a numeric identifier which correlates to its position within that column. Any required media content network requests (which occur when an image or video is downloaded from the webserver 18 during an on-demand presentation) are a side-effect of that state-change. These requests may be triggered by a change in the application state.

In more detail, the column structure and slide content of presentations may be initially defined as a single JavaScript object: a deeply nested tree structure which expresses the content and configuration in their entirety. This object can grow to be quite large (e.g., 5 MB) as more slides are added, which not only yields poor performance when updated in-memory, but also becomes prohibitively slow to transfer over a network and process on the receiving end—the risk being that an instruction such as the changing of a slide may not have been transferred, processed, and applied by the viewer before the presenter makes reference to this change.

A networking performance optimisation may be achieved by splitting this potentially large object into two separate data-structures:
1) A layout map titled “structure”. This keeps track of what the selected presentation is, what the selected columns for each presentation are, and what the selected slides within each column across all presentations are. Slide content is omitted altogether. In other words, the layout map is a map of the structure of the presentation in its two-dimensional configuration with references to the identifiers of the slides.
2) A list of “slides”. This holds all slide content data only, with one piece of metadata per slide: the “position” attribute which maps the slide content to where it belongs in the “structure” layout map.

This use of data structures allows the navigator's presentation application running on the presentation control device 16 to communicate to connected viewers 52 (e.g., someone watching a presentation remotely) in a granular way, communicating only the changes in application state rather than sending the full state over the network at every interaction (i.e., the change is sent, rather than a full copy of the presentation that contains that one change). When a change occurs within the structure (such as changing the current/active slide within a column), only that structure-change is communicated (the ‘structure’ or ‘assembly’ data structure) from the navigator 30 to the connected viewers 52. When a change occurs within a slide (such as changing the active image within a gallery), only that slide-change is communicated (to the slide packet) from the navigator 30 to the connected viewers 52.

Some examples of “structure” (or “assembly”) and “slides” (or “content”) packets are provided below:

### Structure Packet

[structure/_goTo] {s:21,x:1,y:8}
“S” is the presentation's unique identifier, i.e. presentation 21. “X” is the
column number and “y” is the slide number (row) within column X of the two-dimensional grid.

### Slide Packet

[slides/setVideo] {position: {s:21,x:0,y:3}, selectedTimecode:14.5}
This sets the video at the specified position within the slide to have a “time elapsed” value of 14.5 seconds.
[slides/setPano360_Camera_Position] {position:{s:12,x:6,y:2},camera: {x:3.671,y:0.913,z:3.269}}
This sets the camera position and rotation within a 3D environment.
Packets may be compressed and then dispatched through the WebSocket communications protocol.

FIG. 7 shows an example diagram of this embodiment. At a first location, Location 1, there is provided a presentation control device 16, a navigator 30, a first presentation device 14, a presentation screen 10 and a viewer 52. The first presentation device comprises a communications engine 28 with a web browser 26, a processor 24 and data store 22. At a second location, Location 2, there is provided a further presentation screen 10, viewer 52 and second presentation device 14. The second presentation device also comprises a communications engine 28 with a web browser 26, a processor 24 and data store 22. At a third location, Location 3, there is provided a further presentation screen 10, viewer 52 and third presentation device 14. The third presentation device 14 also comprises a communications engine 28 with a web browser 26, a processor 24 and data store 22. There may be any number of presentation devices 14, presentation screens 10 and viewers 52 at remote locations. FIG. 7 also shows a webserver 18 and data store 20. The first, second and third presentation devices and webserver may communicate with each other via the internet 32.

### Environmental Effects

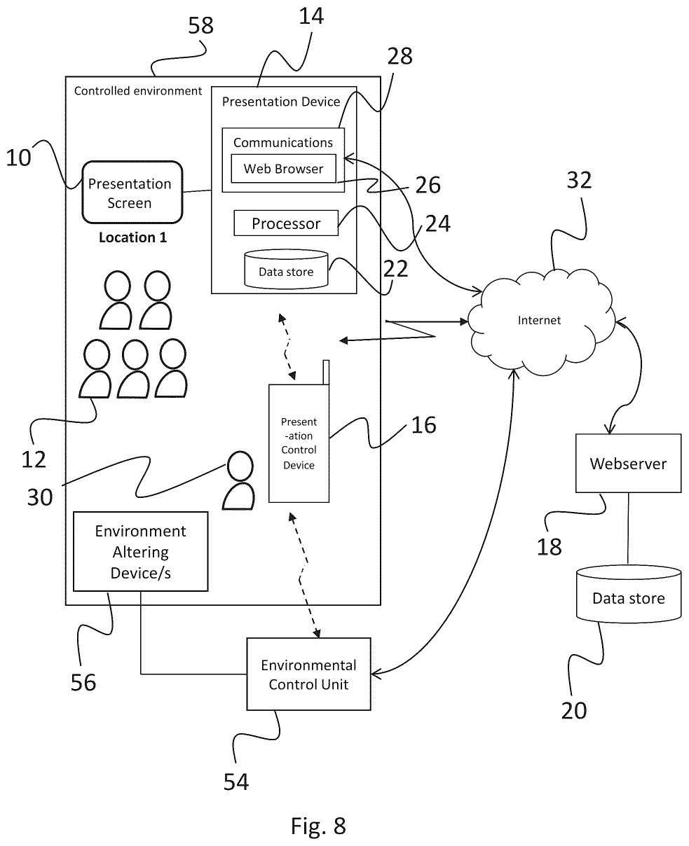

When a one-to-many presentation takes place in a marketing suite (a room specifically prepared for the delivery of this presentation) as shown in FIG. 8, certain environmental controls such as television volume, air-conditioning temperature or lighting configuration may be made available to the presenter. These controls provided in an environmental control unit 54 are directly coupled to and control various environment altering devices 56 such as lighting, speakers and air conditioning units. The environmental controls are triggered by the presentation software application of the presentation control device 16 when a presenter 30 selects a specific slide or performs an action within a slide (e.g., selects a button). The environmental control unit 54 also controls any object within the environment 58 which can support a presentation. For example, a marketing suite may have a physical scale model of a building with an LED light wired into each floor. When a presenter 30 reveals a slide for a floor plan for a specific floor on-screen, that floor's LED bulb in the scale model may also be switched on. When the slide is changed, the light may be turned off automatically.

In other examples, the display of a particular slide or action within a slide may trigger a speaker to output a noise, a smoke machine to output vapor to emulate smoke, an air conditioning unit to output cool air, a heater to heat air, a fan to be activated, a sprinkler or tap to release water, a scent dispenser to output a particular scent, moving parts to start moving (e.g., a moving stage, panels underneath the seats of audience members etc.) and/or an additional display screen to display content (e.g. to display an image or video in a different part of the room to the presentation screen). This can provide audience members 12 with a more immersive and enjoyable experience. For example, the display of a slide relating to a rainforest can trigger the sound of a rainforest to be outputted from a speaker and water to be released from a speaker simulating rain or the display of a slide relating to a tropical beach can trigger a heater to heat the room and a speaker can output the sound of waves.

FIG. 8 shows an example diagram of this embodiment. There is provided a controlled environment 58 which may include the presentation control device 16, navigator 30, presentation screen 10, audience 12, one or more environment altering devices 56 and the presentation device 14 which includes a communications engine 28 with a web browser 26, processor 24 and data store 22. There is also provided a webserver 18, data store 20 and environmental control unit 54. The webserver 18, environmental control unit 54 and features of the controlled environment 58 may be in communication with each other via the internet 32.

It is also to be appreciated that the present embodiments will be well understood by the skilled addressee and that they may be adapted to cover equivalent functions and elements without departure from the present invention as determined by the claims. For example, whilst the present embodiments have been described with reference to a two-dimensional regular grids, and array (regular or non-regular) may be used. For example, certain slides can be presented in a slightly larger size than other slides where there is for example more importance attached to that slide. Also, the grid may be formed by non-square/rectangular elements such as segments. In fact, any shape that can be tessellated can be used as elements of the ‘grid’. Furthermore, elements described in one embodiment may readily be used in another embodiment as would be well understood by the skilled person.

1. A presentation control device for controlling a delivery of a presentation to a presentation screen operated by a presentation device, the presentation comprising a plurality of presentation elements which are each to be displayed individually in a sequence on the presentation screen, the presentation control device comprising:
a graphical user interface providing a navigation layer configured to enable a presenter to select a current presentation element to be displayed, the navigation layer including a representation of each of the presentation elements arranged to show a predetermined default sequence in which each of the presentation elements are to be displayed on the presentation screen, each presentation element having a unique identifier and each representation being linked to a specific one of the presentation elements using the unique identifier;
a presenter input command receiving engine configured to receive a presenter input command and to operate with the navigation layer to enable selection of a specific representation element for display during a presentation, wherein navigation layer is configured to enable selection of the current presentation element which changes the predetermined default sequence; and
a communications engine for transmitting the unique identifier of the currently selected presentation element for display on the presentation screen.

2. The presentation control device of claim 1, wherein the communications engine is configured to transmit the unique identifier of the currently selected presentation element directly to a presentation device via a wireless communications channel or to a remote server to be provided to the presentation device via a wide area network.

3. The presentation control device of claim 1, wherein the communications engine is configured to transmit location information indicating a current position of the currently selected presentation element within the predetermined default sequence of presentation elements.

4. The presentation control device of claim 1, wherein the navigation layer of the graphical user interface comprises a grid-like formation, with units of orthogonal axes of the grid indicating different amounts of movement along the predetermined default sequence to select a current presentation element, wherein optionally the grid-like formation comprises rows and columns and navigation between adjacent rows comprises movement from a current presentation element being displayed to an adjacent presentation element in the predetermined default sequence and navigation between adjacent columns comprises movement from a current presentation element being displayed to a presentation element which is not adjacent in the predetermined default sequence.

5. The presentation control device of claim 1, wherein the graphical user interface is configured to be switchable between a navigation mode in which the navigation layer is displayed on the presentation control device and a presentation mode in which a current presentation slide is displayed on the presentation control device; and wherein optionally the graphical user interface is configured to enable the navigation layer to be overlaid over the current presentation slide displayed on the presentation control device.

6. The presentation control device of claim 1, further comprising a data store for storing a copy of the presentation and for storing a history log of all selections of presentation elements, wherein the navigation layer is configured to record each presentation element selection by the presenter in the history log.

7. The presentation control device of claim 6, wherein the communications engine is configured to transmit the history log, or a part thereof, to a remote server for recordal.

8. A presentation system comprising a presentation control device for controlling a delivery of a presentation to a presentation screen operated by a presentation device, the presentation comprising a plurality of presentation elements which are each to be displayed individually in a sequence on the presentation screen, the presentation control device comprising:
a graphical user interface providing a navigation layer configured to enable a presenter to select a current presentation element to be displayed, the navigation layer including a representation of each of the presentation elements arranged to show a predetermined default sequence in which each of the presentation elements are to be displayed on the presentation screen, each presentation element having a unique identifier and each representation being linked to a specific one of the presentation elements using the unique identifier;
a presenter input command receiving engine configured to receive a presenter input command and to operate with the navigation layer to enable selection of a specific representation element for display during a presentation, wherein navigation layer is configured to enable selection of the current presentation element which changes the predetermined default sequence; and
a communications engine for transmitting the unique identifier of the currently selected presentation element for display on the presentation screen,
the system further comprising a central server operatively coupled to the presentation control device via a communications network, wherein the communications engine of the presentation control device is configured to transmit the unique identifier of the currently selected presentation element to the central server for provision to presentation device via the communications network.

9. The presentation system of claim 8, wherein the central server comprises a cache management engine which is configured to determine a subset of presentation elements are to be selected for rendering based on a location of the current presentation element being displayed within the navigation layer.

10. The presentation system of claim 9, wherein the central server is configured to transmit an identification of the subset of presentation elements selected by the cache management engine to a presentation device via a communications channel, to enable optimised rendering of the subset of presentation elements by the presentation device.

11. The presentation system of claim 8, further comprising the presentation device operating the presentation screen, wherein the presentation device comprises a cache management engine which is configured to determine a subset of presentation elements to be selected for rendering based on a location of the current presentation element being displayed within the navigation layer.

12. The presentation system of claim 9, wherein the cache management engine is configured to determine members of the subset as being any presentation element most likely to be selected for display next, and the cache management engine determines such members based on:
the sequence of presentation elements displayed previously by the presenter navigating the current presentation;
the sequence of presentation elements most commonly displayed by the presenter navigating the current presentation;
the sequence of presentation elements displayed most recently; or
the most typical sequence presentation elements that have been previously displayed, the most typical sequence being determined by reviewing a history of sequences of presentation elements previously displayed.

13. The presentation system of claim 9, wherein the central server comprises a cache management engine which is configured to determine a subset of presentation elements are to be selected for rendering based on the location of the current presentation element being displayed within the navigation layer, wherein the cache management engine is configured to select a subset of the presentation elements of the current presentation for rendering which are located adjacent the location of the current presentation element being displayed within the navigation layer.

14. The presentation system of claim 11, wherein the presentation device comprises a rendering engine which is configured to discard a presentation element which has been rendered but is not part of the subset of the presentation elements determined by the cache management engine.

15. The presentation system of claim 11, wherein the presentation device is configured to preload media content of any of the presentation elements forming part of a subgroup as determined by the cache management engine, wherein the presentation device is optionally configured to preload media content via a web browser.

16. The presentation system of claim 8, where the presentation comprises:
an assembly data structure, identifying a positional arrangement of each presentation element within the navigation layer; and
a content data structure, storing content of each presentation element,
each component of the assembly data structure being associated with component of the content data structure using the unique identifier of each presentation element.

17. The presentation system of claim 11, wherein the presentation device is preloaded with a copy of the presentation in unrendered form.

18. The presentation system of claim 16, wherein the presentation control device is configured to transmit changes in the predetermined default sequence to the assembly data structure and changes in the content of a presentation element to the content data structure.

19. The presentation system of claim 8, further comprising an environment actuator and an environmental control device provided to change a characteristic of the environment at a presentation location, wherein the presentation control device is configured to send a command to the environmental control device to control the environment actuator to change the characteristic of the environment of the presentation, the command being sent when a particular presentation element is displayed on the presentation screen.

20. A method of controlling a delivery of a presentation to a presentation screen operated by a presentation device, the presentation comprising a plurality of presentation elements which are each to be displayed individually in a sequence on the presentation screen, the method comprising:
providing a navigation layer enabling a presenter to select a current presentation element to be displayed, the navigation layer including a representation of each of the presentation elements arranged to show a predetermined default sequence in which each of the presentation elements are to be displayed on the presentation screen, each presentation element having a unique identifier and each representation being linked to a specific one of the presentation elements by the unique identifier;
receiving a presenter input command and operating with the navigation layer to enable selection of a specific representation for display during a presentation, wherein navigation layer is configured to enable selection of the current presentation element which changes the predetermined default sequence; and
transmitting the unique identifier of the currently selected presentation element for display on the presentation screen.
